(19) United States
(12) Patent Application Publication
(10) Pub. No.: US 2012/0236964 A1
(43) Pub. Date: Sep. 20, 2012

(54) SYSTEM AND METHOD FOR REDUCING BIT-ERROR-RATE IN ORTHOGONAL FREQUENCY-DIVISION MULTIPLEXING

(76) Inventor: Dov Wulich, Metar (IL)

(21) Appl. No.: 13/512,360

(22) PCT Filed: Nov. 30, 2010
(86) PCT No.: PCT/IL10/01000

§ 371 Date: May 29, 2012

Related U.S. Application Data
(60) Provisional application No. 61/272,987, filed on Nov. 30, 2009.

(51) Int. Cl. H04B 15/00; H04L 27/28

(52) U.S. Cl. 375/297

(57) ABSTRACT

System and method for reducing BER in OFDM based communication system. A cost function relating the power partition coefficients and the average power emitted by the linear power amplifier at the transmitter during quasistatic periods of the channel may be minimized, solved or estimated, based on the received channel partial CSI, and on knowledge of the linear power amplifier gain and linear dynamic range, to get power partition coefficients. The total available power may be divided among the subcarriers according to the resultant power partition coefficients. Additionally, the OFDM signal may amplified by a variable gain calculated based on the resultant power partition coefficients.

### BACKGROUND OF THE INVENTION

A main drawback of Orthogonal Frequency-Division Multiplexing (OFDM) is its high Peak to Average Power Ratio (PAPR) which requires the use of a Linear Power

Amplifier (LPA) with a large linear dynamic range to avoid signal distortion and spectral re-growth. This linear dynamic range should be set according to the maximal value of the OFDM signal, or if normalized, according to the maximum value of PAPR−PAPRₘ, since otherwise non-linear distortions is likely to appear.

In many modern, OFDM based, communication systems Channel State Information (CSI) could be available at the transmitter which allows the use of an Adaptive Power Loading (APL) algorithm, for example Minimum Bit Error Rate (M-BER) algorithm as described in L. Goldfeld, V. Lyandres, D. Wulich, “Minimum BER power loading for OFDM in fading channels”, IEEE Trans. on Commun, vol. 50, No. 11, November 2002, pp. 1729-173 (hereinafter referred to as “Goldfeld et al.”). For a given total average power available at the transmitter, the M-BER algorithm gives a more optimal power distribution between subcarriers—Power Loading (PL)—to reach minimum BER.

### SUMMARY OF THE INVENTION

According to embodiments of the invention a method for reducing Bit Error Rate (BER) in Orthogonal Frequency-Division Multiplexing (OFDM) transmitter, may comprise: setting power partition coefficients of said OFDM transmitter by periodically solving a cost function relating said power partition coefficients to average power emitted by a linear power amplifier (LPA) of said OFDM transmitter, said cost function may consider partial Channel State Information (CSI) of said channel, and gain and linear dynamic range of said LPA, setting a gain for a variable gain amplifier based on said linear dynamic range and on said power partition coefficients, distributing total available power among subcarriers using said power partition coefficients, and amplifying a transmitted signal of the OFDM transmitter by said gain.

According to embodiments of the invention an OFDM transmitter may comprise: a modified minimum BER (MM-BER) block to set power partition coefficients of said OFDM transmitter by periodically solving a cost function relating said power partition coefficients to average power emitted by a linear power amplifier (LPA), said cost function considering partial Channel State Information (CSI) of said channel, and gain and linear dynamic range of said LPA, a variable gain amplifier to amplify a transmitted signal of said OFDM transmitter by a second gain, said second gain to be set based on said linear dynamic range and on said power partition coefficients, and an OFDM modulator block adapted to distribute total available power among subcarriers using said power partition coefficients.

According to embodiments of the invention the cost function may be given by:

$$\hat{μ} = arg \{ {min}_{μ} [ {F}_{1} ( μ , {P}_{av} ( μ ) ; {\vert h \vert}^{2} , {P}_{max} ) ] \}$$

with a constraint

$${\sum }_{n = 1}^{N} {μ}_{n} = 1.$$

According to embodiments of the invention minimizing said cost function may done numerically or using look-up-table matching possible values of said power partition coefficients and said average power emitted by the LPA.

According to embodiments of the invention a suboptimal solution of said cost function may be obtained by solving f(γₓ)=γₓ wherein the function γₒ=f(γₓ) may be defined by the following chain of equations:

$${γ}_{x} ⇒ {P}_{av} = \frac{{P}_{max}}{{γ}_{x}} ⇒ η = \frac{{P}_{av} T}{{N}_{0}} ⇒ {b}_{n} = {\vert {h}_{n} \vert}^{2} {K}_{M} η ⇒ {\hat{μ}}_{n} = \frac{{b}_{n}}{1 + {b}_{n}^{2}} {( {\sum }_{n = 1}^{N} \frac{{b}_{n}}{1 + {b}_{n}^{2}} )}^{- 1} ⇒ ⇒ {{γ}_{o} ( {\sum }_{n = 1}^{N} \sqrt{{\hat{μ}}_{n}} )}^{2} / {\sum }_{n = 1}^{N} {\hat{μ}}_{n}$$

According to embodiments of the invention the gain may be calculated by:

$$G = \frac{{s}_{max}}{( {\sum }_{n = 1}^{n} \sqrt{\hat{μ}} )} .$$

According to embodiments of the invention the cost function may be solved for every quasistatic period of the channel.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram of an exemplary modified OFDM based transmitter 100 according to embodiments of the invention;

FIG. 2 is a flowchart illustration of a power loading method for reducing Bit Error Rate (BER) in OFDM according to embodiments of the invention;

FIG. 3 is a schematic illustration of comparison of simulation results of the average aggregate BER as a function of the SNR for the numerical solution and for the suboptimal solution according to embodiments of the present invention; and

FIGS. 4A-C show schematic illustration of simulated average aggregate BER as a function of the Signal-to-Noise Ratio (SNR) for M-BER and suboptimal Modified Minimum-BER according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

A system and method for reducing BER in an OFDM based communication system according to embodiments of the present invention may include a variable gain amplifier and Minimum BER power loading block. A cost function relating the power partition coefficients to the average power emitted by the linear power amplifier at the transmitter during quasistatic periods of the channel may be solved or estimated, based on the received channel partial CSI, and on knowledge of the linear power amplifier gain and linear dynamic range, to get power partition coefficients. The total available power may be divided among the subcarriers according to the resultant power partition coefficients. Additionally, the OFDM signal may be amplified by a variable gain calculated based on the resultant power partition coefficients.

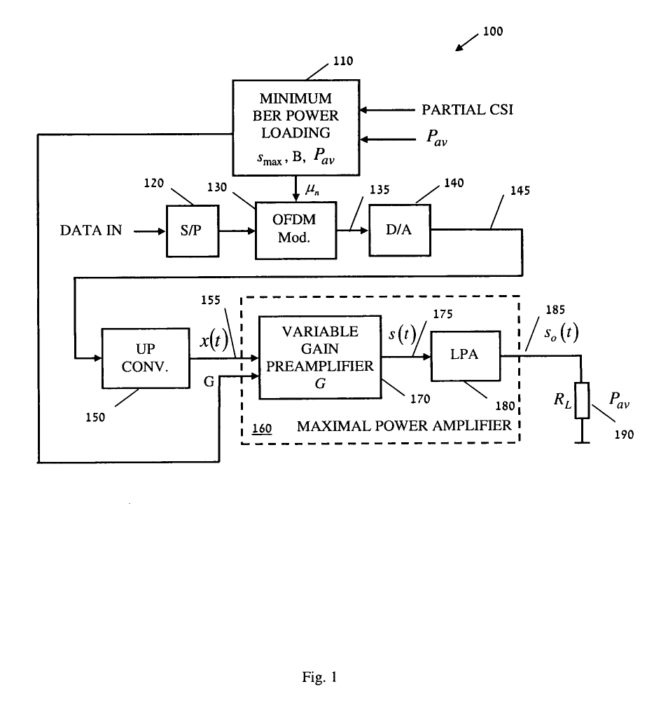

Reference is made to FIG. 1 depicting a schematic diagram of an exemplary modified OFDM based transmitter 100 according to embodiments of the invention. It may be assumed that partial CSI may be known to transmitter 100. The term partial CSI may refer to the absolute values of the channel complex attenuation at the different subcarriers. According to embodiments of the present invention, transmitter 100 may include Minimum BER power loading block 110, Serial to Parallel (S/P) block 120, OFDM modulator block 130, Digital to Analog (D/A) block 140, Up Converter block 150, and Maximal Power Amplifier block 160 comprising a variable gain preamplifier block 170 and a LPA block 180. The load such as antenna, for example, may be represented as a resistor R_{L} 190 connected to ground.

In Serial to Parallel block 120 the input data, which is a serial input bit stream with rate R_{b}, may be buffered into blocks of b=R_{b}·T bits, where T is an OFDM symbol time interval. The blocks may then be divided into N parallel subchannels. The number of bits assigned to the subchannels may be given by bᵢ=b/N, i=1,2, . . . , N. The blocks of bᵢ bits may then be translated into symbols aᵢ, thus yielding an information bearing vector a=[a₁,a₂, . . . , a_{N}], which is also referred to as the payload, where aₙεS and S denotes the constellation. It is noted that embodiments of the invention are not limited to any specific constellation and may operate with any constellation operatable with OFDM based communication systems, that is normalized such that

$$E \{ {\vert {a}_{n} \vert}^{2} \} = 1$$

for n=1,2, . . . , N, where E denotes expected value. Such constellation may include, for example, but not limited to Binary Phase-Shift Keying (BPSK), Quadrature Phase-Shift Keying (QPSK), 8-PSK and M-Quadrature Amplitude Modulation (M-QAM).

OFDM Modulator 130 may transform information bearing vector a into orthogonal subcarriers. OFDM Modulator 130 may be based on Inverse Discrete Fourier Transform (IDFT) of order N, which may be implemented using Inverse Fast Fourier Transform (IFFT) as known in the art. OFDM Modulator 130 may regulate the amplitude of the subcarriers according to the results of the minimum BER power loading algorithm aiming at optimal power allocation between the subcarriers. The output signal of the OFDM modulator 130 may be converted form digital to analog in block 140 and up converted to desired broadcasting frequencies, at block 150, as known in the art.

Let OFDM signal x(t) denote the up-converted output of the OFDM modulator at point 155, that occupies bandwidth W. According to embodiments of the invention, it may be assumed that the channel noise may be substantially white within the frequency range of W.

The PAPR observed at x(t) for tε[0, T_{PL}] may be estimated by:

$$Γ {=}^{def} \frac{{max}_{0 \leq t \leq {T}_{PL}} {\vert x ( t ) \vert}^{2}}{E \{ \frac{1}{{T}_{PL}} {\int }_{- {T}_{PL} / 2}^{{T}_{PL} / 2} {\vert x ( t ) \vert}^{2} d t \}} = \frac{{max}_{0 \leq t \leq {T}_{PL}} {\vert x ( t ) \vert}^{2}}{E \{ {‖ x ‖}_{2}^{2}} , \qquad ( 1 )$$

where T_{PL}=K·T, and K is an integer. As it will be explained later T_{PL} may be related to the quasi-static period of the channel. Γ may be characterized as a discrete-valued random variable with finite maximal value because the max operator in (1) is taken over a finite interval [0, T_{PL}]. T_{PL} may depend on the channel characteristics. For example, for wireless systems operating at frequency of 2.4 GHz T^{PL} may be in the range of several milliseconds for stationary transmitter and receiver. For the OFDM signal x(t),

$$E \{ {‖ x ‖}_{2}^{2} \} = const$$

and it may be assumed that

$$E \{ {‖ x ‖}_{2}^{2} \} = 1.$$

However, it should be noted that this assumption is made for the clarity of the mathematical formulation and presentation only, and does not limit the scope of embodiments of the present invention.

Let Xₙ≧0 denote the amplitude of the signal of the n-th subcarrier. According to embodiments of the invention it may be assumed that {Xₙ}^{N}ₙ₌₁ are constant during time interval [0, T_{PL}]; therefore for any given set of {Xₙ}^{N}ₙ₌₁ the maximal value of Γ equals:

$${γ}_{x} {=}^{def} max ( Γ ) = \frac{{( {\sum }_{n = 1}^{N} {X}_{n} )}^{2}}{{\sum }_{n = 1}^{N} {X}_{n}^{2}} , \qquad ( 2 )$$

According to embodiments of the invention it may be shown that γₓ≦N and the equality holds if and only if loading is uniform. The relation γₓ≦N may be proven by using the Cauchy-Schwartz inequality. The Cauchy-Schwartz inequality in l₂ states that

$${( {\sum }_{n = 1}^{N} {X}_{n} {Y}_{n} )}^{2} \leq {\sum }_{k = 1}^{N} {X}_{n}^{2} \cdot {\sum }_{k = 1}^{N} {Y}_{n}^{2} \qquad ( 3 )$$

and the equality holds if and only if Xₙ=αYₙ, α>0. Assume Yₙ=1 for all n. From (3) it follows that

$${γ}_{x} = {( {\sum }_{n = 1}^{N} {X}_{n} )}^{2} / {\sum }_{n = 1}^{N} {X}_{n}^{2} \leq N \qquad ( 4 )$$

and the equality holds for uniform loading, i.e., Xₙ=const.

According to embodiment of the invention LPA 180 may be practical LPA having gain B and finite linear dynamic range [−sₘₐₓ sₘₐₓ], as known in the art. Throughout the mathematical formulation in the current application LPA 180 may be modeled as a soft limiter. It should be noted that this ideal model is used to simplify the mathematical calculations and other, more realistic models of LPA 180 may be used as well. According to embodiments of the invention, the error that may be introduced by real LPAs exhibiting non-linearities and other deviations from this model are substantially negligible.

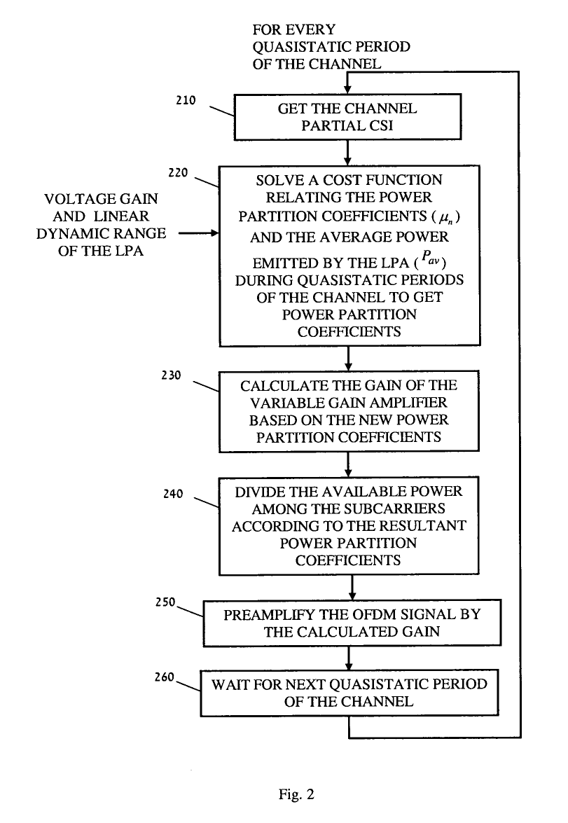

Let s(t) be the input signal (in volts) of the LPA at point 175. According to the LPA model shown in FIG. 2, for |s(t)|≦sₘₐₓ the power amplifier is linear, i.e.,

sₒ(t)=B·s(t), (5)

where sₒ(t) is the output signal (in volts) seen at the load (in ohms) R_{L} of LPA 180 at point 185 and B denotes the voltage gain of LPA 180. To simplify the mathematical calculations, it is assumed that LPA 180 is perfectly matched to its load 190. It should be noted that real life LPAs are typically substantially matched to load 190. Thus, according to embodiments of the invention, the error that may be introduced by real-life imperfect matching between LPA 180 and load 190 are substantially negligible.

The interval [−sₘₐₓ, sₘₐₓ] indicates the linear dynamic range of LPA 180, or in another words, if |s(t)|>sₘₐₓ then the power amplifier may no longer be linear, resulting in non-linear distortions such as clipping.

Let p(t) be the instantaneous power, in watts, seen at the load R_{L}, defined as

$$p ( t ) {=}^{def} \frac{{B}^{2}}{{R}_{L}} \cdot {\vert s ( t ) \vert}^{2} , \qquad ( 6 )$$

The average power emitted by LPA 180 during time interval [0, T_{PL}] may be significantly increased if the signal x(t) is linearly scaled (pre-amplified), prior to being supplied to LPA 180, by a variable gain pre-amplifier 170 with a gain/attenuation given by:

$$G {=}^{def} \frac{{s}_{max}}{{max}_{0 \leq t \leq {T}_{PL}} \vert x ( t ) \vert} , \qquad ( 7 )$$

i.e., now s(t)=G·x(t).
The average power Pₐᵥ emitted by LPA 180 during [0, T_{PL}] may be estimated by

$$\begin{matrix}{P}_{av} = E \{ \frac{1}{{T}_{PL}} {\int }_{0}^{{T}_{PL}} p ( t ) d t \} \\ = \frac{{B}^{2}}{{R}_{L}} \cdot {G}^{2} \cdot \frac{1}{{T}_{PL}} {\int }_{0}^{{T}_{PL}} E \{ {\vert x ( t ) \vert}^{2} \} d t \\ = = \frac{{B}^{2}}{{R}_{L}} \cdot {G}^{2} \cdot \frac{{max}_{0 \leq t \leq {T}_{PL}} {\vert x ( t ) \vert}^{2}}{Γ} \\ = \frac{{B}^{2} {s}_{max}^{2}}{{R}_{L}} \cdot \frac{1}{Γ} \\ = \frac{{P}_{max}}{Γ} ,\end{matrix} \qquad ( 8 )$$

where

$${P}_{max} {=}^{def} \frac{{B}^{2} {s}_{max}^{2}}{{R}_{L}}$$

is the maximal emitted power when s(t)=sₘₐₓ, i.e. when Γ=1, which is the lowest value of PAPR. To avoid clipping we will set Γ=γₓ, therefore

$${P}_{av} = \frac{{P}_{max}}{{γ}_{x}} . \qquad ( 9 )$$

Minimum BER Power Loading may be calculated as described in detail in Goldfeld et al. Accordingly it may be assumed that partial CSI, also denoted as {|hₙ|}^{N}ₙ₌₁ may be known to transmitter 100, where {hₙ}^{N}ₙ₌₁ may be the channel complex attenuation at the n-th subcarrier represented by a set of random variables with substantially the same distribution. T_{PL}, the quasi-static period of the channel, may defined as such an interval for which {|hₙ|}^{N}ₙ₌₁ is substantially constant. Having the above assumed and defined it may be possible to perform Power Loading (PL) according to M-BER algorithm described in Goldfeld et al.

According to Goldfeld et al., M-BER algorithm may provide preferred distribution of the total/average power, Pₐᵥ, available at the transmitter among subcarriers to achieve lower aggregate BER. For the case of independent errors in subchannels, the aggregate BER may be expressed as

$${P}_{er} = 1 - {\prod }_{n = 1}^{N} [ 1 - p ( {SNR}_{n} ) ] , \qquad ( 10 )$$

where P(·) is the bit error probability in the n-th subchannel, and

$${SNR}_{n} = {\vert {h}_{n} \vert}^{2} ( \frac{E}{{N}_{0}} ) {μ}_{n} = {\vert {h}_{n} \vert}^{2} {ημ}_{n} = {η}_{n} {μ}_{n} \qquad ( 11 )$$

is the SNR in the n-th subchannel, E=PₐᵥT is the transmitted energy, and N₀ is the spectral density of the additive white Gaussian noise (AWGN). The power partition coefficients μₙ may be defined as

$${μ}_{n} {=}^{def} \frac{{P}_{av}^{( n )}}{{P}_{av}} , \qquad ( 12 )$$

where pₐᵥ⁽ⁿ⁾ is the power loaded in the n-th subchannel. The power partition coefficients μₙ may be used by OFDM modulator block 130 to scale the amplitudes of the signals at the different subchannels. Minimization of the aggregate BER, given by (10), may be performed with respect to the following constraint

$${\sum }_{n = 1}^{N} {μ}_{n} = 1. \qquad ( 13 )$$

The exact and approximate solutions of the above stated minimization problem are given in Goldfeld et al. for the case of coherent detection where the probability of bit error in the n-th subchannel may be given by

p(SNRₙ)=N_{M}Q(\sqrt{K_{M}|hₙ|²ημₙ}), (14)

where K_{M} depends on the kind of modulation, and N_{M} depends on the actual mapping of the constellation. The exact solution requires the solution of a system of N transcendental equations while the approximate solution gives the weights {μₙ}^{N}ₙ₌₁ explicitly, namely [Goldfeld et al., eq. (17)]

$${\hat{μ}}_{n} = \frac{{b}_{n}}{1 + {b}_{n}^{2}} {( {\sum }_{n = 1}^{N} \frac{{b}_{n}}{1 + {b}_{n}^{2}} )}^{- 1} , \qquad ( 15 )$$

where

$${b}_{n} {=}^{def} {\vert {h}_{n} \vert}^{2} {K}_{M} η .$$

The solution (15) may be valid for a period T_{PL}, the quasi-static period of the channel. The approximate solution (15) may be used hereinafter.

According to embodiments of the invention, the maximal value of the PAPR observed at sₒ(t), during tε[0, T_{PL}], due to M-BER may be given by

$${γ}_{0} = \frac{{( {\sum }_{n = 1}^{N} \sqrt{{\hat{μ}}_{n}} )}^{2}}{{\sum }_{n = 1}^{N} {\hat{μ}}_{n}} . \qquad ( 16 )$$

However, for given {|hₙ|}^{N}ₙ₌₁ the distribution of \hat{μ}ₙ may depend on Pₐᵥ, which in turn may depend on {\hat{μ}ₙ}^{N}ₙ₌₁ via γₓ—see (9). Therefore, according to embodiments of the present invention, the interdependency between \hat{μ}ₙ and Pₐᵥ should be part of the cost function. Therefore, a new cost function and in fact a new APL algorithm may be defined. The PL scheme associated with the new cost function will be referred to as Modified Minimum BER (MM-BER).

By introducing (14) into (10) the M-BER problem may be expressed as the constrained minimization of a cost function F₀

$$\hat{μ} = arg \{ {min}_{μ} [ {F}_{0} ( μ ; {P}_{av} , {\vert h \vert}^{2} ) ] \} \qquad ( 17 )$$

with a constraint

$${\sum }_{n = 1}^{N} {μ}_{n} = 1.$$

For M-BER, the OFDM signal x(t) may be scaled to fulfill

$${max}_{0 \leq t \leq ∞} \vert s ( t ) \vert \leq {s}_{ma x} .$$

That is, the maximal possible value of the signal s(t) throughout the entire transmission, which is formulated as time 0≦t≦∞, may be within the linear dynamic range of the input signal. Thus, the OFDM signal x(t) may be scaled for uniform power loading for which, according to Property 1, the emitted power may be minimal and equal to

$${P}_{av} = \frac{{P}_{m ax}}{N} . \qquad ( 18 )$$

To achieve MM_BER it is proposed to modify the problem by introducing and then minimizing a new cost function F₁

$$\hat{μ} = arg \{ {min}_{μ} [ {F}_{1} ( μ , {P}_{av} ( μ ) ; {\vert h \vert}^{2} , {P}_{ma x} ) ] \} \qquad ( 19 )$$

with a constraint

$${\sum }_{n = 1}^{N} {μ}_{n} = 1.$$

The function F¹ may be obtained from F⁰ by replacing constant

$${P}_{av} by {P}_{av} ( μ ) = {P}_{ma x} / {γ}_{x} ( μ ) = {P}_{ma x} / {( {\sum }_{n = 1}^{N} \sqrt{{μ}_{n}} )}^{2} .$$

Now the OFDM signal x(t) may be scaled to fulfill

$${max}_{0 \leq t \leq {T}_{PL}} \vert s ( t ) \vert \leq {s}_{m ax} .$$

That is, only the maximal quasistatic value of s(t) may be within the linear dynamic range of the input signal. Thus, the scaling may change for different periods of T_{PL}. The finer scaling of the OFDM signal x(t) according to embodiments of the present invention, may result in a more optimal utilization of the linear range of LPA 180, and thus, the output signal seen at the load sₒ(t) may have higher amplitudes and power values in comparison to the output signal of power loading schemes known in the art. As known in the art, increasing the amplitude and power of the transmitted signal is related to reduction in BER values. It should be noted that other, short enough time intervals in which value of s(t) may be within the linear dynamic range of the input signal may be specified.

For scaling according to embodiments of the present invention, the power emitted by the LPA may substantially equal P^{av}(μ)=Pₘₐₓ/γₓ(μ) which in turn may depend on μ. Solution of (19) may provide, substantially optimal values of \hat{μ} to be fed into OFDM block 130 and substantially optimal values of G to be fed into variable gain amplifier 170 to be used during the quasistatic period.

According to embodiments of the present invention Equation 19 may be solved, for example, by minimum BER power loading block 110, periodically. For example, 19 may be solved for substantially every quasistatic period of the system. It should be noted that according to embodiments of the invention, other time intervals for solving equation 19 may be defined. Equation 19 may be solved numerically using, for example gradient method or bisection method or any suitable numerical method that may reach minimum of the cost function F₁. Alternatively, minimum BER power loading block 110 may comprise a memory block (not shown) that may store a look-up-table (LUT) that may match possible values of Pₐᵥ with possible values of μ. The quasistatic gain G of the variable gain preamplifier may be calculated by

$$G = \frac{{s}_{ma x}}{( {\sum }_{n = 1}^{n} \sqrt{\hat{μ}} )} .$$

This may be a modification of equation 7 where G depends explicitly on power loading coefficients.

Alternatively, according to embodiments of the present invention, a suboptimal solution of equation 19 may be estimated by the following procedure. According to the suboptimal solution of embodiments of the preset invention, a relationship γₒ=f(γₓ) may be defined by the following chain of equations:

$$\begin{matrix}{γ}_{x} ⇒ {P}_{av} = \frac{{P}_{ma x}}{{γ}_{x}} ⇒ η \\ = \frac{{P}_{av} T}{{N}_{0}} ⇒ {b}_{n} \\ = {\vert {h}_{n} \vert}^{2} {K}_{M} η ⇒ {\hat{μ}}_{n } \\ = \frac{{b}_{n}}{1 + {b}_{n}^{2}} {( {\sum }_{n = 1}^{N} \frac{{b}_{n}}{1 + {b}_{n}^{2}} )}^{- 1} ⇒ {γ}_{0} ⇒ \\ = {( {\sum }_{n = 1}^{N} \sqrt{{\hat{μ}}_{n}} )}^{2} / {\sum }_{n = 1}^{N} {\hat{μ}}_{n}\end{matrix} \qquad ( 20 )$$

The proposed suboptimal solution may be based on the solution of f(γₓ)=γₓ. f(γₓ)=γₓ may be solved using any iterative method, such as, for example, the bisection method, linear searching or gradient method. Let γ^{sub}^{_{—}}^{opt} be a solution of f(γₓ)=γₓ; the suboptimal power partition coefficients \hat{μ}^{sub}^{_{—}}^{opt} may be calculated according the following chain of equations:

$$\begin{matrix}{γ}^{sub \_ opt} ⇒ {P}_{av}^{sub \_ opt} = \frac{{P}_{ma x}}{{γ}^{sub \_ opt}} ⇒ {η}^{sub \_ opt} \\ = \frac{{P}_{av}^{sub \_ opt} T}{{N}_{0}} ⇒ {b}_{n}^{sub \_ opt} \\ = {\vert {h}_{n} \vert}^{2} {K}_{M} {η}^{sub \_ opt} ⇒ {\hat{μ}}_{n}^{sub \_ opt} \\ = \frac{{b}_{n}^{sub \_ opt}}{1 + {( {b}_{n}^{sub \_ opt} )}^{2}} {( {\sum }_{n = 1}^{N} \frac{{b}_{n}^{sub \_ opt}}{1 + {( {b}_{n}^{sub \_ opt} )}^{2}} )}^{- 1}\end{matrix} \qquad ( 21 )$$

The quasistatic gain of variable gain preamplifier may be set to:

$$G = \frac{{s}_{max}}{( {\sum }_{n = 1}^{N} \sqrt{{\hat{μ}}_{n}^{sub\_opt}} )} \qquad ( 22 )$$

According to the embodiment of the present invention preamplifying of the OFDM signal by the calculated gain G may be performed by variable gain amplifier G 170 which may be located after up converter 150 and before LPA 180. Variable gain amplifier G may be a component that may vary its gain according to a control signal. Variable gain amplifier G may be any commercially available variable or controllable gain amplifier having gain range, bandwidth, linearity, noise figure suitable for OFDM, such as, for example, operational amplifier Alternatively, variable gain amplifier G may be specially designed and implemented on Very-Large-Scale Integration (VLSI) integrated circuits as known in the art. It should be noted, however, that preamplifying of the OFDM signal by the calculated gain G may be done anywhere along the flow of the OFDM signal from the output of OFDM modulator 130 to the input of LPA 180. For example, the digital OFDM signal may be preamplified in the digital domain at point 135 before being converted to an analog signal, or at point 145 in the analog domain, before being up converted.

Reference is now made to FIG. 2 which is a flowchart illustration of a power loading method for reducing BER in OFDM according to embodiments of the invention. According to embodiments of the invention, in substantially every quasistatic period of the channel, the channel partial CSI may be received, as indicated at block 210. In block 220 a cost function relating the power partition coefficients (μₙ) and the average power emitted by the LPA (Pₐᵥ) during quasistatic periods of the channel may be solved or estimated, based on the received channel partial CSI, and on knowledge of the LPA gain and linear dynamic range, to get power partition coefficients. For example, the cost function may be equation 19. According to embodiments of the present invention, solving equation 19 may be done numerically or using LUT. Alternatively, a suboptimal solution of equation 19 may be estimated by iteratively solving of f(γₓ)=γₓ defined by the chain of equations 20. The gain of the variable gain amplifier may be calculated by, for example, equation 22, as indicated in block 230. At block 240 the total available power may be divided among the subcarriers according to the resultant power partition coefficients and at block 250 the OFDM signal may be amplified by the calculated gain. This process may be repeated for substantially every quasistatic period of the channel, as indicated in block 260.

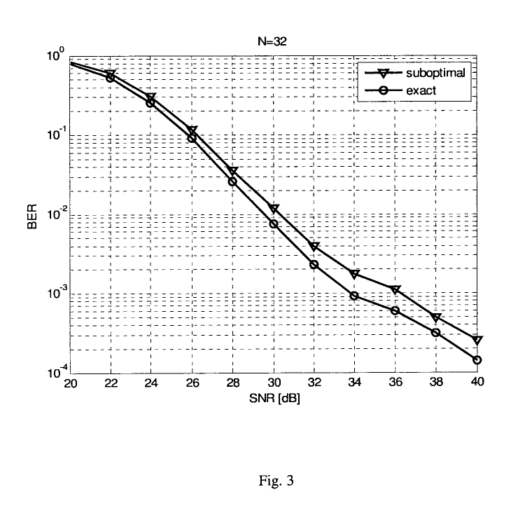

Reference is now made to FIG. 3 which depicts comparison of simulation results of the average aggregate BER as a function of the SNR for the numerical solution of equation 19 and for the suboptimal solution as presented in equations 20 according to embodiments of the present invention. OFDM with 32 subcarriers and Rayleigh fading channel was considered. The SNR may be defined as

$$η = \frac{{P}_{av} T}{{N}_{0}} = \frac{{P}_{max} T}{N \cdot {N}_{0}} .$$

It may be clearly demonstrated that the suboptimal solution may be sufficiently close to the numerical one and thus may be suitable for practical implementations of MM-BER. The number of iterations of the suboptimal solution presented in FIG. 3 is 11.

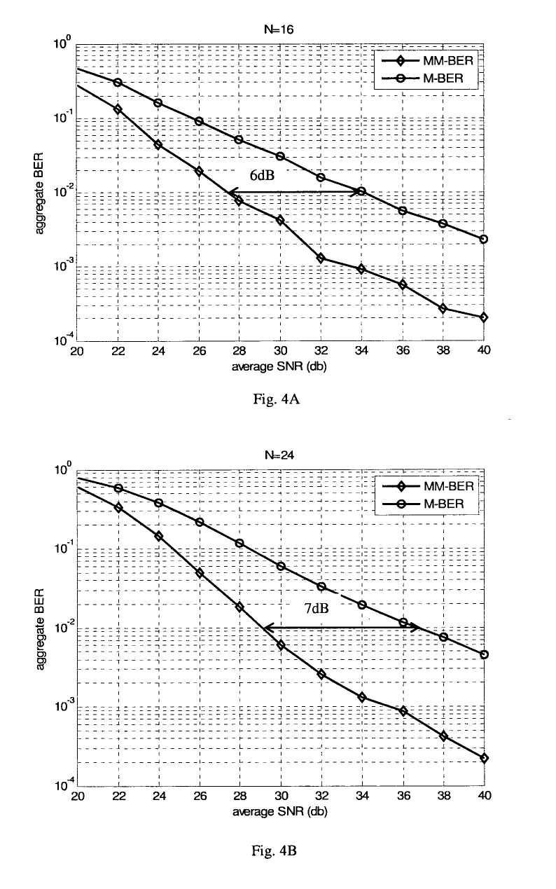

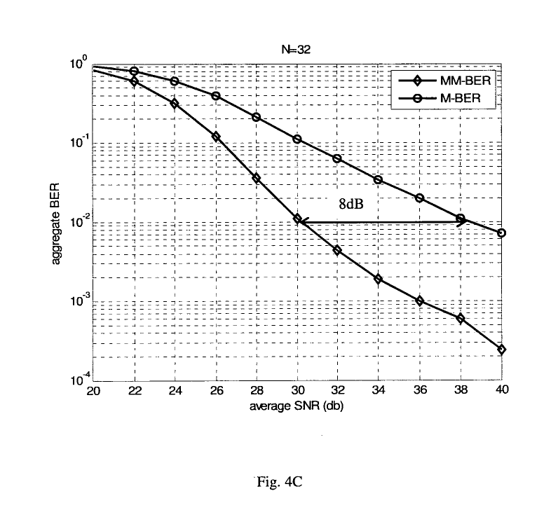

Reference is now made to FIGS. 4A-C which show the simulated average aggregate BER as a function of the SNR for M-BER and suboptimal MM-BER for K_{M}=2 and N_{M}=1. FIGS. 4A, 4B and 4C depict simulation results for performance M-BER and suboptimal MM-BER for N=16, N=24 and N=32, respectively. If one assumes the same BER for M-BER and MM-BER, then a SNR gain in favor of MM-BER is observed. Inspection of FIGS. 4A-C reveal that SNR gain is about 6-8 dB, depending on N.

Some embodiments of the present invention may be implemented in software for execution by a processor-based system, for example, minimum BER power loading block 110. For example, embodiments of the invention may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories

(EEPROMs), magnetic or optical cards, or any type of media suitable for storing electronic instructions, including programmable storage devices. Other implementations of embodiments of the invention may comprise dedicated, custom, custom made or off the shelf hardware, firmware or a combination thereof.

Embodiments of the present invention may be realized by a system that may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for reducing Bit Error Rate (BER) in Orthogonal Frequency-Division Multiplexing (OFDM) transmitter, the method comprising:
setting power partition coefficients of said OFDM transmitter by periodically solving a cost function relating said power partition coefficients to average power emitted by a linear power amplifier (LPA) of said OFDM transmitter, said cost function considering partial Channel State Information (CSI) of said channel, and gain and linear dynamic range of said LPA;
setting a gain for a variable gain amplifier based on said linear dynamic range and on said power partition coefficients;
distributing total available power among subcarriers using said power partition coefficients; and
amplifying a transmitted signal of the OFDM transmitter by said gain.

2. The method of claim 1, wherein said cost function is given by:
$$\hat{μ} = arg \{ {min}_{μ} [ {F}_{1} ( μ , {P}_{av} ( μ ) ; {\vert h \vert}^{2} , {P}_{max} ) ] \}$$
with a constraint
$${\sum }_{n = 1}^{N} {μ}_{n} = 1.$$

3. The method of claim 2, wherein solving said cost function is done numerically.

4. The method of claim 2, wherein solving said cost function is done using look-up-table matching possible values of said power partition coefficients and said average power emitted by the LPA.

5. The method of claim 2, wherein a sub optimal solution of said cost function is obtained by solving f(γₓ)=γₓ wherein the function yₒ=f(γₓ) is defined by the following chain of equations:
$${γ}_{x} ⇒ {P}_{av} = \frac{{P}_{max}}{{γ}_{x}} ⇒ η = \frac{{P}_{av} T}{{N}_{0}} ⇒ {b}_{n} = {\vert {h}_{n} \vert}^{2} {K}_{M} η ⇒ {\hat{μ}}_{n} = \frac{{b}_{n}}{1 + {b}_{n}^{2}} {( {\sum }_{n = 1}^{N} \frac{{b}_{n}}{1 + {b}_{n}^{2}} )}^{- 1} ⇒ ⇒ {γ}_{o} = {( {\sum }_{n = 1}^{N} \sqrt{{\hat{μ}}_{n}} )}^{2} / {\sum }_{n = 1}^{N} {\hat{μ}}_{n}$$

6. The method of claim 1, said gain is calculated by:
$$G = \frac{{s}_{max}}{( {\sum }_{n = 1}^{n} \sqrt{\hat{μ}} )} .$$

7. The method of claim 1, wherein said cost function is solved for every quasistatic period of the channel.

8. An OFDM transmitter comprising:
a modified minimum BER (MM-BER) block to set power partition coefficients of said OFDM transmitter by periodically solving a cost function relating said power partition coefficients to average power emitted by a linear power amplifier (LPA), said cost function considering partial Channel State Information (CSI) of said channel, and gain and linear dynamic range of said LPA;
a variable gain amplifier to amplify a transmitted signal of said OFDM transmitter by a second gain, said second gain to be set based on said linear dynamic range and on said power partition coefficients; and
an OFDM modulator block adapted to distribute total available power among subcarriers using said power partition coefficients.

9. The OFDM transmitter of claim 8, wherein said cost function is given by:
$$\hat{μ} = arg \{ {min}_{μ} [ {F}_{1} ( μ , {P}_{av} ( μ ) ; {\vert h \vert}^{2} , {P}_{max} ) ] \}$$
with a constraint
$${\sum }_{n = 1}^{N} {μ}_{n} = 1.$$

10. The OFDM transmitter of claim 9, wherein solving said cost function is done numerically.

11. The OFDM transmitter of claim 9, wherein solving said cost function is done using look-up-table matching possible values of said power partition coefficients and said average power emitted by the LPA.

12. The OFDM transmitter of claim 9, wherein a sub optimal solution of said cost function is obtained by solving f(γₓ)=γₓ where the function γₒ=f(γₓ) is defined by the following chain of equations:
$${γ}_{x} ⇒ {P}_{av} = \frac{{P}_{max}}{{γ}_{x}} ⇒ η = \frac{{P}_{av} T}{{N}_{0}} ⇒ {b}_{n} = {\vert {h}_{n} \vert}^{2} {K}_{M} η ⇒ {\hat{μ}}_{n} = \frac{{b}_{n}}{1 + {b}_{n}^{2}} {( {\sum }_{n = 1}^{N} \frac{{b}_{n}}{1 + {b}_{n}^{2}} )}^{- 1} ⇒ ⇒ {γ}_{o} = {( {\sum }_{n = 1}^{N} \sqrt{{\hat{μ}}_{n}} )}^{2} / {\sum }_{n = 1}^{N} {\hat{μ}}_{n} .$$

13. The OFDM transmitter of claim 8, said gain is calculated by:
$$G = \frac{{S}_{max}}{( {\sum }_{n = 1}^{n} \sqrt{\hat{μ}} )} .$$

14. The OFDM transmitter of claim 8, wherein said cost function is solved for every quasistatic period of the channel.

15. A computer readable medium having stored thereon instructions which when executed by a processor cause the processor to perform the method of:
setting power partition coefficients of an OFDM transmitter by periodically solving a cost function relating said power partition coefficients to average power emitted by a linear power amplifier (LPA) of said OFDM transmitter, said cost function considering partial Channel State Information (CSI) of said channel, and gain and linear dynamic range of said LPA;
setting a gain for a variable gain amplifier based on said linear dynamic range and on said power partition coefficients;
distributing total available power among subcarriers using said power partition coefficients; and
amplifying a transmitted signal of said OFDM transmitter by said gain.

16. The computer readable medium of claim 15, wherein said cost function is given by:
$$\hat{μ} = arg \{ {min}_{μ} [ {F}_{1} ( μ , {P}_{av} ( μ ) ; {\vert h \vert}^{2} , {P}_{max} ) ] \}$$
with a constraint
$${\sum }_{n = 1}^{N} {μ}_{n} = 1.$$

17. The computer readable medium of claim 16, wherein solving said cost function is done numerically.

18. The computer readable medium of claim 16, wherein solving said cost function is done using look-up-table matching possible values of said power partition coefficients and said average power emitted by the LPA.

19. The computer readable medium of claim 16, wherein a sub optimal solution of said cost function is obtained by solving f(γₓ)=γₓ were the function γₒ=f(γₓ) is defined by the following chain of equations:
$${γ}_{x} ⇒ {P}_{av} = \frac{{P}_{max}}{{γ}_{x}} ⇒ η = \frac{{P}_{av} T}{{N}_{0}} ⇒ {b}_{n} = {\vert {h}_{n} \vert}^{2} {K}_{M} η ⇒ {\hat{μ}}_{n} = \frac{{b}_{n}}{1 + {b}_{n}^{2}} {( {\sum }_{n = 1}^{N} \frac{{b}_{n}}{1 + {b}_{n}^{2}} )}^{- 1} ⇒ ⇒ {γ}_{o} = {( {\sum }_{n = 1}^{N} \sqrt{{\hat{μ}}_{n}} )}^{2} / {\sum }_{n = 1}^{N} {\hat{μ}}_{n} .$$

20. The computer readable medium of claim 15, said gain is calculated by:
$$G = \frac{{S}_{max}}{( {\sum }_{n = 1}^{n} \sqrt{\hat{μ}} )} .$$

21. The computer readable medium of claim 15, wherein said cost function is solved for every quasistatic period of the channel.
